(19) United States
(12) Patent Application Publication
(10) Pub. No.: US 2025/0200185 A1
(43) Pub. Date: Jun. 19, 2025

(54) DATA UPDATE SYSTEM, NON-TRANSITORY COMPUTER READABLE MEDIUM STORING PROGRAM THEREFOR, AND METHOD THEREFOR

(71) Applicant: NEC Corporation, Minato-ku, Tokyo (JP)

(72) Inventors: Yoshihiro KOHTA, Tokyo (JP); Hideyuki SHINTANI, Tokyo (JP)

(73) Assignee: NEC Corporation, Minato-ku, Tokyo (JP)

(21) Appl. No.: 18/846,787

(22) PCT Filed: Mar. 29, 2022
(86) PCT No.: PCT/JP2022/015489

§ 371 Date: Sep. 13, 2024

(51) Int. Cl. G06F 21/57; B60L 53/66; G06F 21/62

(52) U.S. Cl. CPC G06F 21/572; B60L 53/66; G06F 21/62

(57) ABSTRACT

A data update system according to an example embodiment performs: in a user terminal, authentication request processing for transmitting authentication information including at least an authentication code displayed on a charging stand, user information registered in advance, and position information of the charging stand and the user terminal to a center server; in the center server, authentication processing for confirming whether or not the authentication information is valid and distribution processing for causing the charging stand to download software to be updated in response to the authentication processing confirming the validity; and in the charging stand, authentication code provision processing for providing the authentication code in response to a connection of a charging cable to a vehicle and data update processing for providing the downloaded software to a vehicle to be updated through a communication line.

### TECHNICAL FIELD

The present invention relates to a data update system, a non-transitory computer readable medium storing a program therefor, and a method therefor, and in particular, to a data update system, a program therefor, and a method therefor by which data installed in a vehicle is updated.

### BACKGROUND ART

In recent years, the number of pieces of software installed in an automobile (hereinafter referred to as a vehicle) has increased enormously, and software for controlling such a vehicle has also become complicated. Therefore, it is required to update software installed in a vehicle in order to be able to cope with a malfunction in the vehicle or improve the functioning of the vehicle. However, software for controlling a vehicle is related to the safety of the vehicle, and thus it is required to ensure a high level of security when it is updated. Patent Literature 1 discloses an example of a technology related to an update of a program installed in a vehicle.

In Patent Literature 1, for example, FIG. 193 and paragraph [0649] disclose that security is ensured by dividing a program storage area in accordance with a communication form as to whether a transmission method for a program is wired or wireless.

### CITATION LIST

### Patent Literature

### Patent Literature 1: Japanese Unexamined Patent Application Publication No. 2020-27626

### SUMMARY OF INVENTION

### Technical Problem

However, there is a problem that, in the method disclosed in Patent Literature 1, data cannot be stored in accordance with the importance of data such as software to be downloaded to a vehicle or vehicle body data to be downloaded from a vehicle, and thus a sufficient level of security cannot be ensured.

In view of the above-described problem, an object of the present invention is to provide a data update system, a program therefor, and a method therefor by which data is updated while a high security level is maintained.

### Solution to Problem

A data update system according to an example embodiment includes: a user terminal operated by a user; a center server configured to perform authentication processing and distribution of data; and a charging stand including a charging cable connected to a vehicle and a communication line through which data communication with the vehicle is performed, the charging stand being configured to charge the vehicle, in which the user terminal performs authentication request processing for transmitting authentication information including at least an authentication code provided by the charging stand to the center server, the center server performs authentication processing for confirming whether or not the authentication information is valid, and distribution processing for causing the charging stand to download the software to be updated in response to the authentication processing confirming the validity, and the charging stand performs authentication code provision processing for providing the authentication code in response to a connection of the charging cable to the vehicle, and data update processing for updating data of a vehicle to be updated by providing the downloaded data to the vehicle to be updated through the communication line.

A data update program according to an example embodiment is a data update program executed in a data update system including a center server, a charging stand, and a user terminal by a calculation unit provided in each of these apparatuses, in which a first program executed in the user terminal performs authentication request processing for transmitting authentication information including at least an authentication code displayed on the charging stand to the center server, a second program executed in the center server performs authentication processing for confirming whether or not the authentication information is valid, and distribution processing for causing the charging stand to download data to be updated in response to the authentication processing confirming the validity, the charging stand includes a charging cable connected to a vehicle and a communication line through which data communication with the vehicle is performed, and a third program executed in the charging stand performs authentication code provision processing for providing the authentication code in response to a connection of the charging cable to the vehicle, and data update processing for providing the downloaded data to a vehicle to be updated through the communication line.

A data update method according to an example embodiment is a data update method performed in a data update system including a center server, a charging stand, and a user terminal, in which in the user terminal, authentication request processing for transmitting authentication information including at least an authentication code displayed on the charging stand to the center server is performed, in the center server, authentication processing for confirming whether or not the authentication information is valid and distribution processing for causing the charging stand to download data to be updated in response to the authentication processing confirming the validity are performed, the charging stand includes a charging cable connected to a vehicle and a communication line through which data communication with the vehicle is performed, and in the charging stand, authentication code provision processing for providing the authentication code in response to a connection of the charging cable to the vehicle and data update processing for providing the downloaded data to a vehicle to be updated through the communication line are performed.

### Advantageous Effects of Invention

By the data update system, the program therefor, and the method therefor according to the present invention, it is possible to update data while a high security level is maintained.

### BRIEF DESCRIPTION OF DRAWINGS

FIG. 1 is a block diagram of a data update system according to a first example embodiment;

FIG. 2 is a hardware configuration diagram of a center server according to the first example embodiment;

FIG. 3 is a hardware configuration diagram of a charging stand according to the first example embodiment;

FIG. 4 is a hardware configuration diagram of a user terminal according to the first example embodiment;

FIG. 5 is a hardware configuration diagram of a vehicle according to the first example embodiment;

FIG. 6 is a sequence diagram for explaining a first example of a procedure for updating data according to the first example embodiment;

FIG. 7 is a sequence diagram for explaining a second example of a procedure for updating data according to the first example embodiment;

FIG. 8 is a sequence diagram for explaining a third example of a procedure for updating data according to the first example embodiment;

FIG. 9 is a sequence diagram for explaining a fourth example of a procedure for updating data according to the first example embodiment;

FIG. 10 is a sequence diagram for explaining an example of a procedure in a case in which validation is performed when parameters are updated according to the first example embodiment; and

FIG. 11 is a sequence diagram for explaining a procedure for updating data according to a second example embodiment.

### EXAMPLE EMBODIMENT

For the clarification of the description, the following descriptions and the drawings are partially omitted and simplified as appropriate. Further, elements described in the drawings as functional blocks which perform various types of processing may be configured as regards hardware by a Central Processing Unit (CPU), a memory, or other circuits, and are implemented as regards software by a program etc. loaded in a memory. Therefore, it will be understood by those skilled in the art that these functional blocks may be implemented in various forms such as hardware only, software only, or a combination thereof, and the present disclosure is not limited to any of them. Note that the same elements are denoted by the same reference numerals or symbols throughout the drawings, and redundant descriptions are omitted as necessary.

Further, the aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-ROM (Read Only Memory), CD-R, CD-R/W, and semiconductor memories (such as mask ROM,

PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires and optical fibers) or a wireless communication line.

### First Example Embodiment

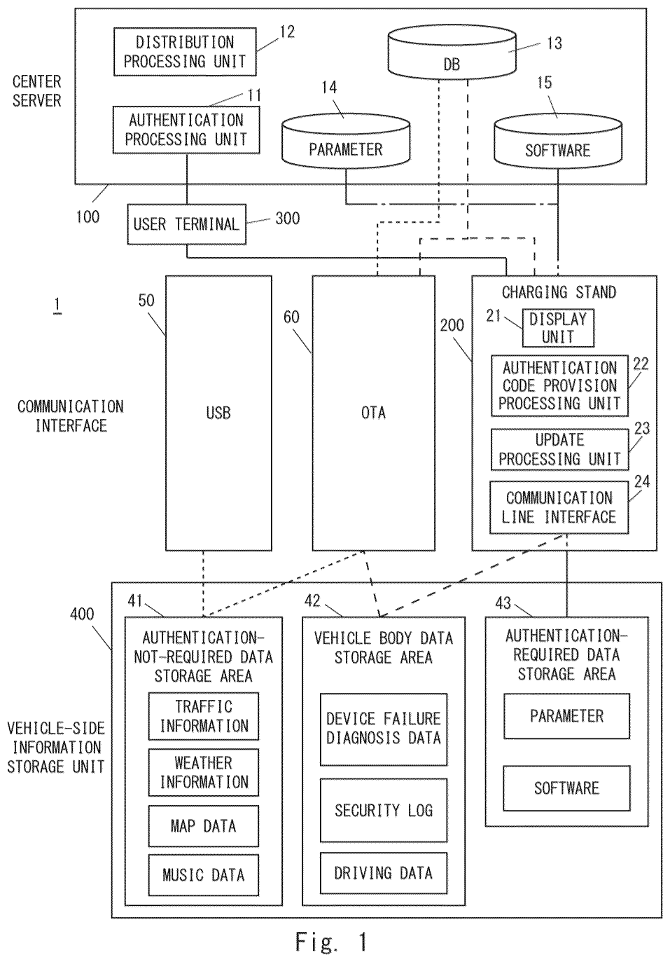

FIG. 1 is a block diagram of a data update system 1 according to a first example embodiment. As shown in FIG. 1, the data update system 1 according to the first example embodiment includes a center server 100, a charging stand 200, a user terminal 300, and a vehicle 400. Note that the data update system 1 updates data stored in the vehicle 400. This data is not limited to software and parameters for controlling the vehicle, and may include data other than such software and parameters. In the following description, an example of a case in which software and parameters are data to be updated will be described. The vehicle 400 is an automobile in which software to be updated by the data update system 1 is installed, for example, an electric vehicle that requires charging or a plug-in hybrid vehicle.

Further, FIG. 1 shows a Universal Serial Bus (USB: registered trademark) interface 50 and an Over The Air (OTA) interface 60 as interfaces that transfer data to the vehicle 400. Note that the OTA interface 60 is an interface that transfers data using radio communication, and is a general term for a communication path in which one or more various communication standards, such as a mobile phone communication network and Wi-Fi, are combined with each other. The vehicle 400 is configured so that it can retrieve or read data through the various communication paths described above.

The center server 100 includes an authentication processing unit 11, a distribution processing unit 12, a database 13, a parameter storage unit 14, and a software storage unit 15. The authentication processing unit 11 confirms whether or not authentication information sent from the user terminal 300 is valid, and permits the distribution of data (e.g., software and parameters) to be updated by the distribution processing unit 12 when the validity of the authentication information is confirmed (the authentication processing has confirmed the validity). Note that the authentication processing unit 11 performs authentication using information included in the authentication information. Regarding this authentication, in authentication processing for identifying a user, authentication can be performed by various methods, such as an authentication processing using an ID, a password, and the like as information for identifying a user and biometric authentication processing using biometric information preset by a user. The distribution processing unit 12 causes the charging stand 200 to download the software to be updated in response to the authentication processing confirming the validity. Further, in response to the authentication processing performed by the authentication processing unit 11 confirming the validity, the distribution processing unit 12 causes the charging stand 200 to download parameters for controlling a vehicle or reads these parameters from the vehicle 400.

The database 13 accumulates vehicle body data such as device failure diagnosis data, security logs, and driving data stored in the vehicle 400. The validity and contents of the vehicle body data are analyzed by a developer or a mechanic of the vehicle manufacturer. The parameter storage unit 14 stores parameters stored in the vehicle 400 and new parameters to be provided to the vehicle 400. The parameters are used for a drive control and an operation control of the vehicle 400 and require a high security level. Further, a developer or a mechanic of the vehicle manufacturer instructs the update of the parameters. Software to be updated is stored in the software storage unit 15. The software stored in the software storage unit 15 performs, for example, a drive control and an operation control of the vehicle 400 and requires a high security level.

The charging stand 200 includes a display unit 21, an authentication code provision processing unit 22, an update processing unit 23, and a communication line interface 24.

The display unit 21 displays various types of information about charging of the vehicle and updating of data to a user. Further, the display unit 21 serves as an input unit that can receive instructions from a user when it includes, for example, a touch panel or the like. That is, the display unit 21 is one of the user interfaces for enabling a user to use the data update system 1.

The authentication code provision processing unit 22 provides an authentication code in response to the connection of a charging cable to the vehicle 400. In the following description, as an example of a method for providing the authentication code, a method for displaying the authentication code on the display unit 21 will be described. However, the authentication code may instead be transmitted by means of short-range radio communication, wireless LAN, a public communication network, or the like. Further, the authentication code is, for example, a one-time password that can be used in the data update system 1. The format of the authentication code may be a plurality of numbers, and various formats such as a QR code (registered trademark) may be employed.

The update processing unit 23 performs data update processing for updating data (e.g., software and parameters) of a vehicle to be updated by providing downloaded data to the vehicle to be updated through the communication line. The communication line interface 24, which is provided in the charging stand 200, is an interface circuit for driving a communication line that serves as a communication path between the charging stand 200 and the vehicle 400 to perform communication between the charging stand 200 and the vehicle 400. Further, the charging stand 200 includes a charging cable (not shown) for charging the vehicle 400. The charging cable may be provided separately from a communication line connected to the vehicle 400 through the communication line interface 24. However, a description will be given below of an example of a case in which the communication line is provided integrally with the charging cable in order to reduce the number of operations performed by a user. By using the physical communication line and the charging cable in this manner, it is possible to prevent the vehicle 400 from being accessed through an unauthorized communication line, and thus to increase the security level.

The user terminal 300 is a terminal operated by a user. For example, a personal digital assistant such as a smartphone capable of communicating with the outside using a mobile phone communication network, Wi-Fi, and the like, a car navigation terminal, or the like may be used as the user terminal 300. The user terminal 300 performs authentication request processing for transmitting authentication information including at least an authentication code provided by the charging stand 200 to the center server 100. The authentication information may further include user information registered in advance, position information of the charging stand and the user terminal, and other information. The user terminal 300 is provided with an apparatus for acquiring an authentication code generated by the vehicle 400, such as a touch panel, an image pickup device such as a camera, and a short-range radio communication interface. Further, the user terminal 300 is provided with a display unit which can display information obtained from the center server 100 and the charging stand 200 and an interface screen generated by application software executed on the user terminal 300.

The vehicle 400 is an apparatus including data to be updated. The vehicle 400 includes a first information accumulation unit (e.g., an authentication-not-required data storage area 41), a second information accumulation unit (e.g., a vehicle body data storage area 42), and a third information accumulation unit (e.g., an authentication-required data storage area 43), accessible communication paths of which are restricted.

The authentication-not-required data storage area 41 is an information storage area in which access is restricted except for access via a wired connection (e.g., the USB interface 50) using a standard cable that is not managed by a vehicle manufacturer or access via a wireless connection (e.g., the OTA interface 60). The authentication-not-required data storage area 41 stores, for example, traffic information, weather information, map data, and music data in which authentication is not required. Data stored in the authentication-not-required data storage area 41 is data which does not greatly affect the control of the vehicle 400 and which is not problematic even when its security level is low. The USB interface 50 and the OTA interface 60 are set as communication paths through which the authentication-not-required data storage area 41 can be accessed.

The vehicle body data storage area 42 is an information storage area in which access is restricted except for access via the OTA interface 60 and a communication line provided in the charging stand 200. That is, in the vehicle body data storage area 42, access via a connection form other than a wireless connection is restricted except for access via a wired connection using a communication line provided in the charging stand 200. The vehicle body data storage area 42 stores vehicle body data generated by the operation of the vehicle 400, such as device failure diagnosis data, security logs, and driving data. Since these pieces of vehicle body data are obtained by operating the vehicle 400 and do not affect the control of the vehicle 400, their security levels may be low. However, these pieces of data include that on the privacy of a driver, and therefore a higher security level is required for them than that required for authentication-not-required data. For this reason, the communication lines provided in the OTA interface 60 and the charging stand 200 are set as communication paths through which the vehicle body data storage area 42 can be accessed.

The authentication-required data storage area 43 is an information storage area in which access except for access via a communication line provided in the charging stand 200 is restricted. That is, in the authentication-required data storage area 43, access via a connection form other than a wired connection using a communication line provided in the charging stand 200 is restricted. The authentication-required data storage area 43 stores, for example, data or programs used for a drive control and an operation control of the vehicle 400, such as parameters and software. The above information is necessary for the safe operation of the vehicle 400 and greatly affects the control of the vehicle 400, and thus a high security level is required therefor. Therefore, only the communication line provided in the charging stand 200 is set as a communication path through which the authentication-required data storage area 43 can be accessed.

Next, an example of a detailed hardware configuration of each of the center server 100, the charging stand 200, the user terminal 300, and the vehicle 400 will be described.

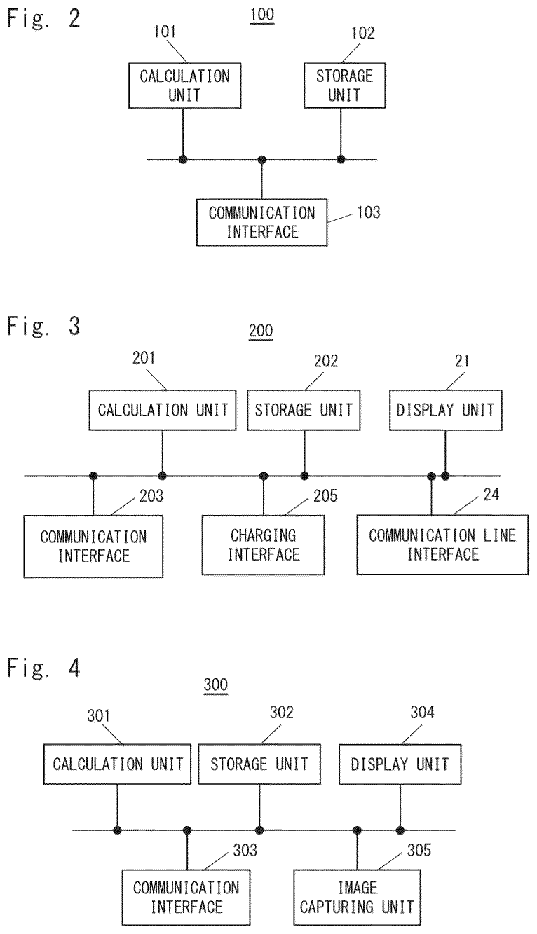

First, FIG. 2 shows a hardware configuration diagram of the center server 100 according to the first example embodiment. The center server 100 includes, for example, hardware provided in a computer. Specifically, in the center server 100, a calculation unit 101, a storage unit 102, and a communication interface 103 are connected to each other so that they can communicate with each other through a bus. The calculation unit 101 executes a second program included in a data update program. The calculation unit 101 that executes the second program performs authentication processing performed by the authentication processing unit 11 and distribution processing performed by the distribution processing unit 12. The storage unit 102 is implemented by a storage device such as a memory, a Solid State Disk (SSD), or a Hard Dick Drive (HDD), and serves as the database 13, the parameter storage unit 14, and the software storage unit 15. Note that the database 13, the parameter storage unit 14, and the software storage unit 15 may be configured by a housing different from that of the calculation unit 101. The communication interface 103 is an interface circuit that communicates with the charging stand 200 and the user terminal 300 wirelessly or by wire.

Next, FIG. 3 shows a hardware configuration of the charging stand 200 according to the first example embodiment. The charging stand 200 can be implemented as a computer having a charging function. In the example shown in FIG. 3, in the charging stand 200, a calculation unit 201, a storage unit 202, the display unit 21, a communication interface 203, a charging interface 205, and the communication line interface 24 are connected to each other so that they can communicate with each other through a bus. The calculation unit 201 executes a third program included in the data update program. The calculation unit 201 that executes the third program performs authentication code provision processing performed by the authentication code provision processing unit 22 and data update processing performed by the update processing unit 23. The storage unit 202 is a storage device that holds downloaded software and parameters. The display unit 21 is the display unit 21 described with reference to FIG. 1, and may have not only a display function but also an input function using a touch panel or the like. The communication interface 203 is an interface circuit that communicates with the center server 100 and the user terminal 300, and either a wired or a wireless communication may be performed in this interface circuit. The charging interface 205 is an interface circuit to which a charging cable is connected, and feeds a charging current to the vehicle 400. The communication line interface 24 is connected to a communication line, and communicates with the vehicle 400 through the communication line.

Next, FIG. 4 shows a hardware configuration diagram of the user terminal 300 according to the first example embodiment. The user terminal 300 can be implemented as a computer having an image capturing function. In the example shown in FIG. 4, in the user terminal 300, a calculation unit 301, a storage unit 302, a communication interface 303, a display unit 304, and an image capturing unit 305 are connected to each other so that they can communicate with each other through a bus. The calculation unit 301 executes a first program included in a data update program. The calculation unit 301 that executes the first program performs authentication request processing for transmitting authentication information including at least an authentication code displayed on the charging stand 200, user information registered in advance, and position information of the charging stand 200 and the user terminal to the center server 100. The storage unit 302 is a storage apparatus device that holds the retrieved authentication code, position information, and the like. The communication interface 303 is an interface circuit that communicates with the center server 100 and the charging stand 200, and either a wired or a wireless communication may be performed in this interface circuit. For example, the communication interface 303 may have a short-range radio communication function, and the user terminal 300 and the charging stand 200 may communicate with each other using the short-range radio communication function, thereby obtaining an authentication code. The display unit 304 may have not only a display function but also an input function using a touch panel or the like. The display unit 304 displays a user interface screen generated by the first program executed by the calculation unit 301. The image capturing unit 305 is, for example, a camera, and can be configured so as to receive an authentication code by reading a QR code displayed on the display unit 21 of the charging stand 200.

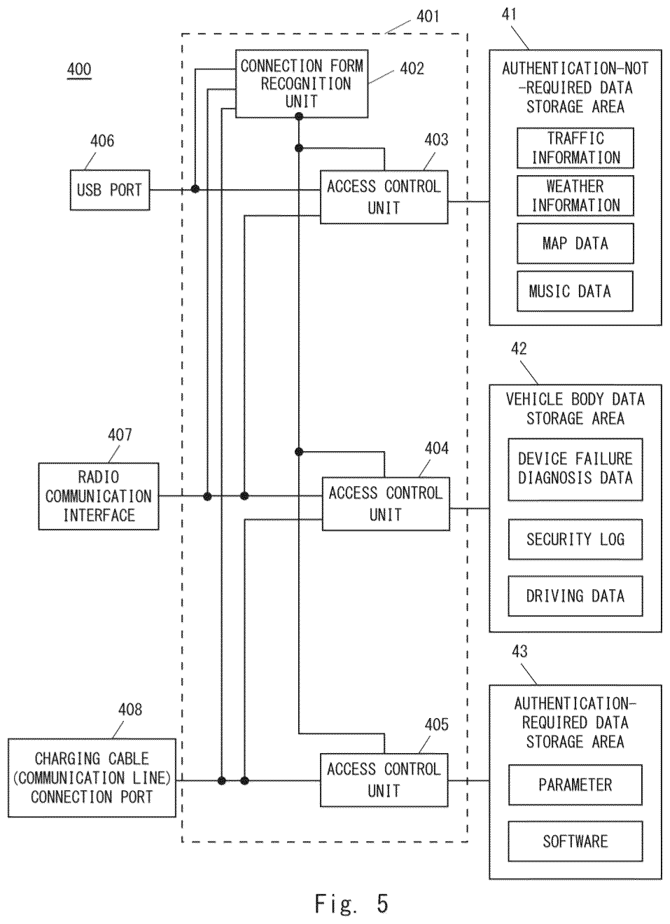

Next, FIG. 5 shows a hardware configuration diagram of the vehicle 400 according to the first example embodiment. In FIG. 5, only some of the components of the vehicle 400 that relate to a path for accessing the authentication-not-required data storage area 41, the vehicle body data storage area 42, and the authentication-required data storage area 43 from the outside are shown. The vehicle 400 includes the authentication-not-required data storage area 41, the vehicle body data storage area 42, and the authentication-required data storage area 43 in which respective paths for accessing these areas are restricted. Further, the vehicle 400 includes a USB connection port 406, a radio communication interface 407, and a charging cable connection port 408 as input/output interfaces of the access paths. Note that, in the vehicle 400, the charging cable connection port 408 also serves as a connection port for a communication line that is a communication path with the charging stand 200. Further, the vehicle 400 includes an access guard unit 401 between the USB connection port 406, the radio communication interface 407, and the charging cable connection port 408, and the authentication-not-required data storage area 41, the vehicle body data storage area 42, and the authentication-required data storage area 43.

The access guard unit 401 recognizes forms of connection with an external apparatus or medium, and controls an access range in accordance with a difference in the forms of connection. Further, the access guard unit 401 recognizes at least a wired connection by a communication line provided in the charging stand 200 and a radio connection as the forms of connection. More specifically, the access guard unit 401 recognizes the standard of a cable to be connected and a difference in the forms of connection, that is, whether the form of connection is the wired connection or the wireless connection, and controls the access range in accordance with the standard of the cable and the difference in the forms of connection. Note that the access control performed by the access guard unit 401 may include either writing or reading to and from each of the information storage areas, or may include both writing and reading thereto and therefrom. More specifically, the access guard unit 401 includes a connection form recognition unit 402 and access control units 403 to 405. The connection form recognition unit 402 recognizes which of the USB connection port 406, the radio communication interface 407, and the charging cable connection port 408 is enabled, and gives a passage permission to the access control unit corresponding to the enabled port/interface. The access control unit 403 switches between enabling and disabling of a path for accessing the authentication-not-required data storage area 41 through the USB connection port 406 and the radio communication interface 407. The access control unit 404 switches between enabling and disabling of a path for accessing the vehicle body data storage area 42 through the radio communication interface 407 and the charging cable connection port 408. The access control unit 405 switches between enabling and disabling of a path for accessing the authentication-required data storage area 43 through the charging cable connection port 408. That is, in the vehicle 400, the access guard unit 401 restricts the information storage area accessible for each communication interface.

Next, operations performed by the data update system 1 according to the first example embodiment will be described. In the data update system 1 according to the first example embodiment, four examples of operations for updating data using the charging stand 200 can be considered, which operation is used depending on whether or not data is updated and whether or not parameters are updated. The four examples of operations will be described below as first to fourth examples. Further, in the sequence diagram described below, it is assumed that a user has previously registered user information such as the name of the user, the telephone number of the user terminal 300, the license number of a vehicle to be used, the vehicle identification number, and identification information (e.g., a user ID) in the database 13 of the center server 100 by using the user terminal 300. Note that, although a description will be given of an example of a case in which data to be updated is at least one of software and parameters, the data to be updated is not limited to software and parameter.

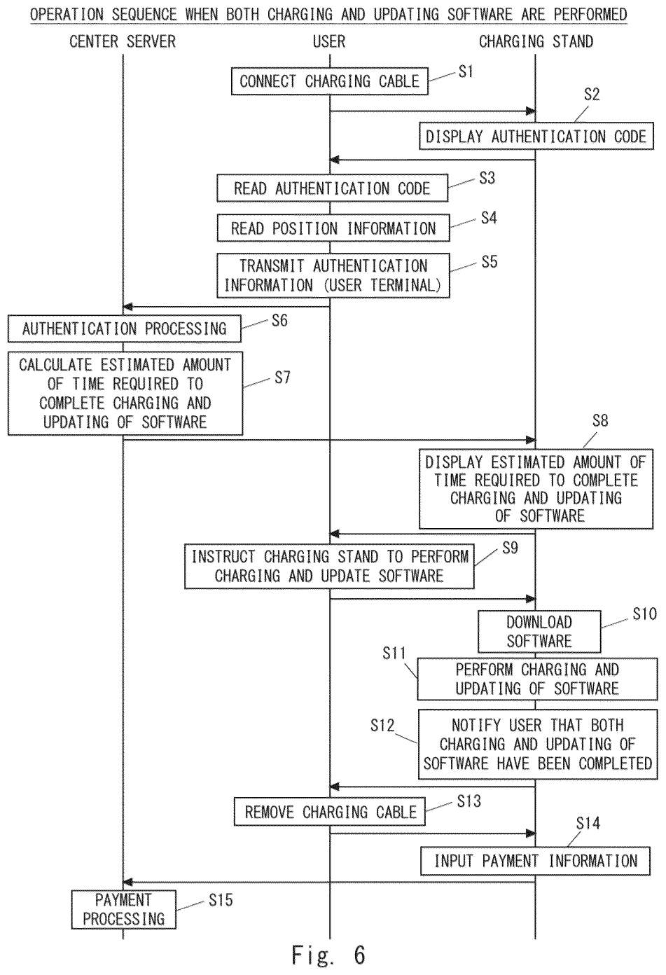

FIG. 6 is a sequence diagram for explaining the first example of a procedure for updating data according to the first example embodiment. This first example is an example of an operation in a case in which both charging and updating software are performed. As shown in FIG. 6, in the first example, the operation of the data update system 1 is started when a user connects the charging cable of the charging stand 200 to the vehicle 400 (Step S1). When the charging stand 200 recognizes that the charging cable is connected to the vehicle 400, the charging stand 200 displays an authentication code on the display unit 21 (Step S2). Then the user reads the authentication code displayed on the display unit 21 by using the user terminal 300 (Step S3). Further, in the user terminal 300, when the authentication code is read, position information at this point of time is read by using a GPS function or the like (Step S4). In the data update system 1, GPS information of the user terminal 300 can be regarded as being position information of the user terminal 300 and the charging stand 200 since the user is present in an area where the user can operate the charging cable of the charging stand 200. Next, the user terminal 300 generates authentication information including at least the authentication code read in Step S3, the position information of the charging stand 200 and the user terminal 300 read in Step S4, and the user information registered in advance, and transmits the generated authentication information to the center server 100 (Step S5).

Next, the center server 100 performs authentication processing for performing validation of the received authentication information while referring to the user information stored in the database 13 (Step S6). Then, in response to the authentication processing confirming the validity, the distribution processing unit 12 calculates an amount of time required to complete the charging and the updating of data as an estimated amount of time (Step S7). The center server 100 transmits the calculated amount of time in Step S7 to the charging stand 200.

Next, the charging stand 200 displays the received estimated amount of time calculated as the amount of time required to complete the charging and the updating of data on the display unit 21 (Step S8). The user checks the estimated amount of time displayed on the display unit 21 and instructs the charging stand 200 to perform charging and update data (Step S9). Note that the instruction in Step S9 may be given using the user terminal 300 or through the display unit 21 of the charging stand 200.

Then, in response to the instruction in Step S9, the charging stand 200 downloads software to be updated from the center server 100 (Step S10). Then the charging stand performs the charging and the updating of data in parallel (Step S11). In Step S11 above, the charging stand 200 provides to the vehicle 400 the software to be updated which is downloaded in Step S10 from the center server 100. By performing the charging and the updating of data simultaneously in this way, it is possible to prevent, when data is being updated, the updating of data from being stopped in the middle thereof due to a shortage in the power supply capacity. Then, in response to the completion of both the charging and the updating of data, the charging stand 200 notifies the user that both the charging and the data update processing have been completed (Step S12). The notification in Step S12 may be sent to the user terminal 300 or may be displayed on the display unit 21.

Then, when the user has removed the charging cable from the vehicle 400 (Step S13), a request for inputting payment information is displayed on the display unit 21 of the charging stand 200, and when the payment information is input to the display unit 21 (Step S14), the center server 100 executes payment processing (Step S15). Note that, regarding a procedure for inputting the payment information in Step S14, the timing at which the payment information is input can be appropriately changed in accordance with the specifications of the system, such as the timing before the instruction for the charging and the updating of software in Step S9.

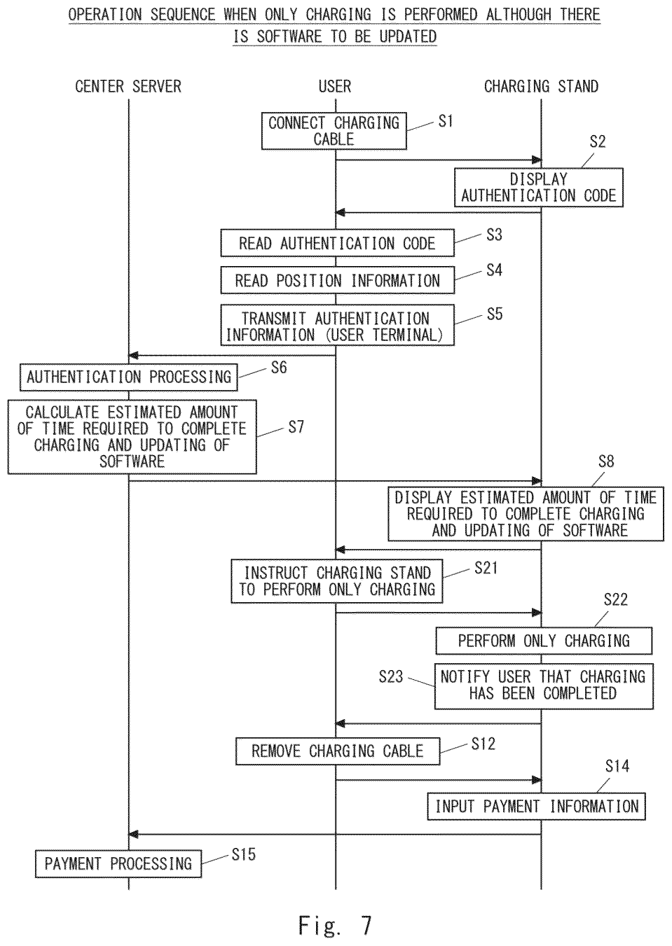

Next, the second example of the operation performed by the data update system 1 will be described. The second example is an example of an operation in a case in which a notification about a request for updating software is sent to a user but the software will be updated later due to a time constraint of the user. FIG. 7 is a sequence diagram for explaining the second example of a procedure for updating data according to the first example embodiment.

As shown in FIG. 7, in the second example, Steps S9 to S12 in the first example are replaced by Steps S21 to S23. In Step S21, a user instructs the charging stand 200 to perform only charging without selecting the updating of data. By doing so, the charging stand 200 performs only charging (Step S22), and notifies the user that the charging has been completed in response to the completion of the charging (Step S23).

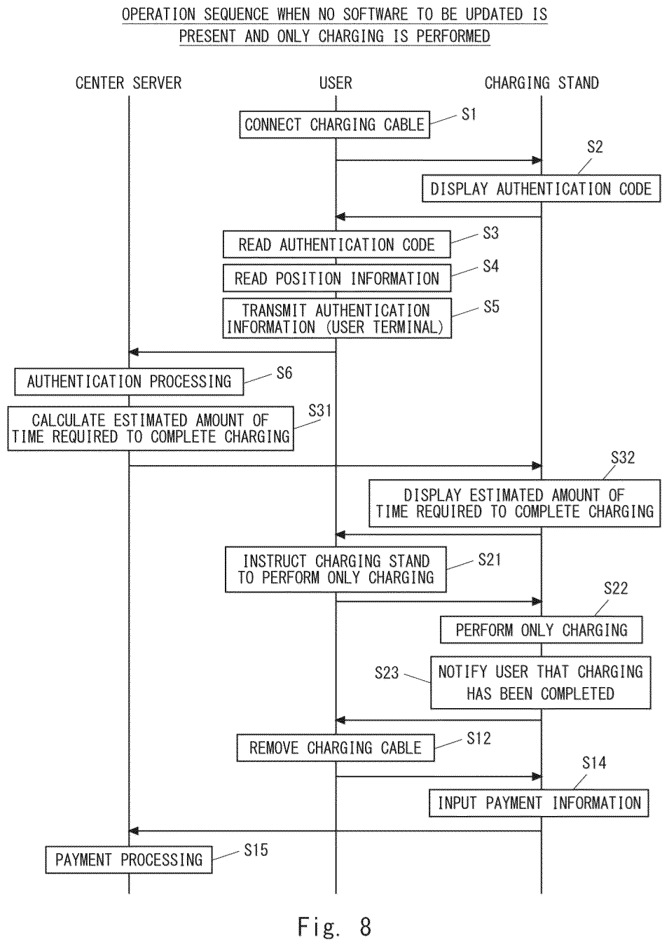

Next, the third example of the operation performed by the data update system 1 will be described. The third example is an example of an operation in a case in which no software to be updated is present and only charging is performed. FIG. 8 is a sequence diagram for explaining the third example of a procedure for updating data according to the first example embodiment.

As shown in FIG. 8, in the third operation example, Steps S7 and S8 in the second operation example are replaced by Steps S31 and S32. In the third example, since data is not updated, an estimated amount of time is calculated for only charging (Step S31). In the third example, the estimated amount of time displayed on the display unit 21 is only the estimated amount of time required to complete the charging (Step S32).

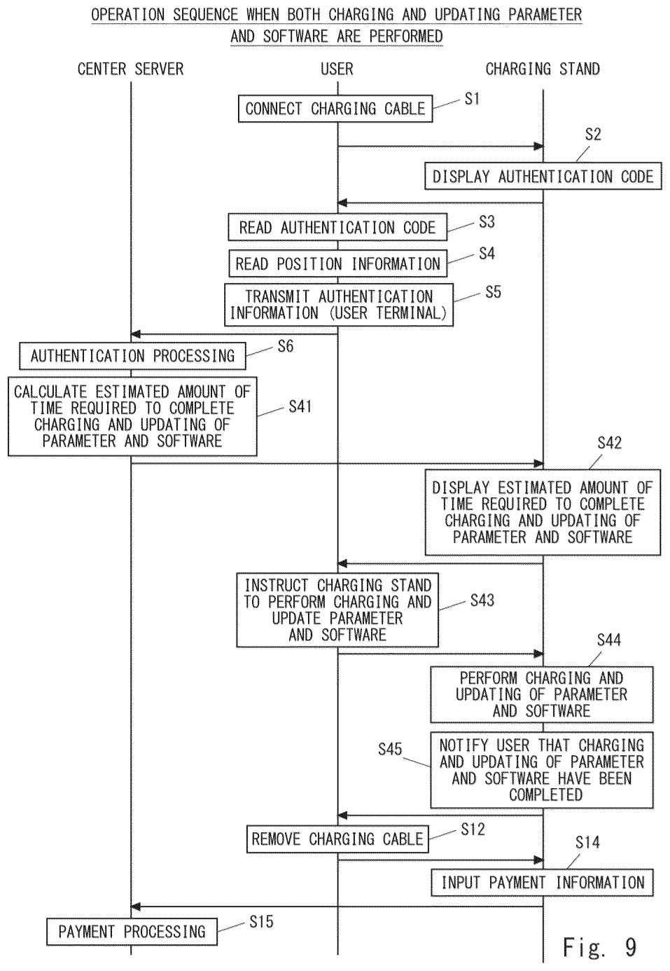

Next, the fourth example of the operation performed by the data update system 1 will be described. The fourth example is an example of an operation in a case in which both charging and updating both parameters and software are performed. FIG. 9 is a sequence diagram for explaining the fourth example of a procedure for updating data according to the first example embodiment. As shown in FIG. 9, in the fourth example, Steps S7 to S12 in the first example are replaced by Steps S41 to S45. Note that parameters may be updated remotely by a mechanic through the center server 100.

In Step S41, an estimated amount of time required to update parameters is calculated in addition to an estimated amount of time required to perform charging and update data. Then the center server 100 causes the display unit 21 of the charging stand 200 to display the estimated amount of time calculated in Step S41 (Step S42). Next, a user instructs the charging stand 200 to perform charging, update parameters, and update data (Step S43). In response to the instruction from the user, the charging stand 200 performs both charging and updating parameters and software (Step S44). Then, in response to the completion of all the processes in Step S44, the charging stand 200 notifies the user that the processes have been completed (Step S45).

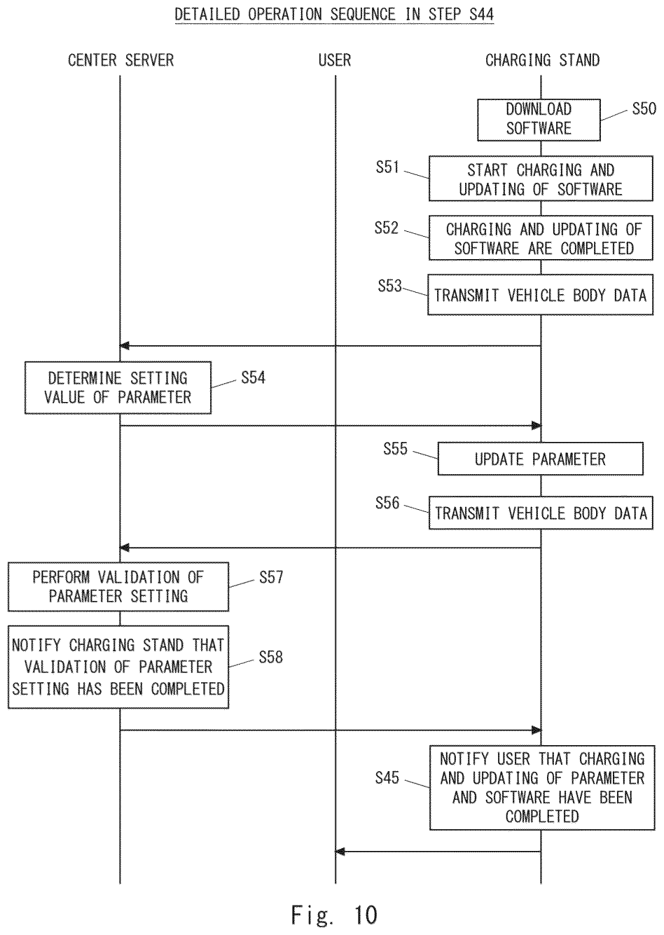

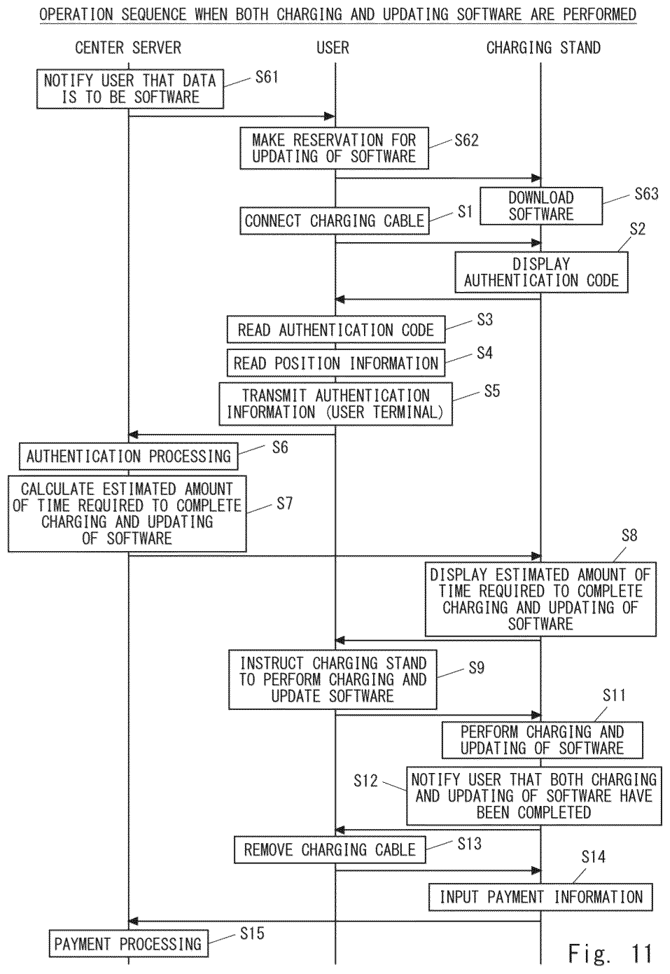

Note that, in the updating of parameters and data in Step S44, validation of the state of the vehicle after the updating can be performed. FIG. 10 is a sequence diagram for explaining an example of a procedure in a case in which validation of the state of the vehicle is performed when parameters are updated according to the first example embodiment.

The example in FIG. 10 shows processes performed in Step S44. As shown in FIG. 10, in Step S44, first, the charging stand 200 downloads software to be updated from the center server 100 (Step S50). Then, at the same time when the charging stand 200 charges the vehicle 400, the downloaded software is provided to the vehicle 400 and data is updated (Step S51). Then, in response to the completion of the updating of the data (Step S52), the charging stand 200 reads vehicle body data from the vehicle 400 and transmits the current vehicle body data to the center server 100 (Step S53). A mechanic or the like determines setting values of the parameters while referring to the vehicle body data downloaded from the vehicle 400 (Step S54). Then the parameters to be updated are downloaded from the center server 100 to the charging stand 200. Then the charging stand 200 transmits the downloaded parameters to the vehicle 400, and the vehicle 400 updates the parameters (Step S55). Then the vehicle 400 transmits the vehicle body data including at least device failure diagnosis data to the center server 100 (Step S56).

Then, in the center server 100, validity diagnosis processing for performing validation of the parameter setting is performed by a program executed by the calculation unit 101 (Step S57). Note that examples of means for performing the validation of the parameter setting include means for checking a state of the vehicle (a sound of the driving motor of the vehicle) by a person who performs diagnosis after the parameters are changed. Then, when there is no problem in the validity of the parameter setting, the center server 100 notifies the charging stand 200 that the validation of the parameter setting has been completed (Step S58), and the charging stand 200 notifies a user that the process has been completed as Step S45. By performing the validation of the parameter setting in this way, the validity of updating of data can be confirmed.

As described above, in the data update system 1 according to the first example embodiment, multi-step authentication can be performed by using an authentication code displayed on the charging stand 200 and user information and position information generated in the user terminal 300, and hence it is possible to prevent software having a low security level and lacking validity from being installed in the vehicle 400. For example, it is possible to prevent vehicle body data from being updated when the user terminal of an unauthorized user accesses the center server 100. Further, it is possible to prevent vehicle body data from being updated when the center server 100 is accessed from a position other than the position of the authorized charging stand. That is, the security level of software installed in the vehicle 400 can be improved by using the data update system 1.

Further, in the data update system 1, it is possible to prevent the updating of data from being stopped due to an insufficient charging by performing both charging and updating software.

Further, since an information storage area accessible in accordance with a connection path is restricted in the vehicle 400, the security level of software stored in the authentication-required data storage area 43 can be increased.

Further, by integrating the communication line with the charging cable in the data update system 1, the number of cables handled by a user can be reduced to one, and thus the data update system 1 is highly convenient. Furthermore, in the data update system 1, by presenting the amount of time required to update software to a user and the user then selecting whether or not to update the software, it is possible to prevent the user from having a feeling that the user is being put at a disadvantage due to the updating of data being performed in a period of time during which the vehicle is not used but which is not sufficient for updating the data.

### Second Example Embodiment

In a second example embodiment, an example of a case in which data (e.g., software) to be updated is downloaded to the charging stand 200 in advance will be described. FIG. 11 shows a sequence diagram for explaining a procedure for updating data according to the second example embodiment.

As shown in FIG. 11, in the second example embodiment, processes of Steps S61 to S63 are added before the process of Step S1 in the first example shown in FIG. 6. Further, in the second example embodiment, download processing of Step S10 in the first example shown in FIG. 6 is not performed. The center server 100 notifies the user terminal 300 used by a user that data is to be updated (Step S61). Then the user makes a reservation for the updating of data with the charging stand 200 based on the details in the notification sent to the user terminal 300 (Step S62). Then the charging stand 200 downloads the software to be updated from the center server 100 based on the reservation made in Step S62 (Step S63).

As described above, the amount of time required to update data can be reduced by downloading software to be updated to the charging stand 200 in advance. Note that, in the second example embodiment, it is preferable that the charging stand 200 with which a reservation for the updating of data is made can be specified in advance. In particular, when there is a charging stand provided at home, it is easy to specify the charging stand 200 to which software is downloaded in advance as described above, and thus the example described in the second example embodiment is particularly useful in the data update system 1 including the charging stand 200 installed at home.

Note that the present invention is not limited to the above-described example embodiments and may be changed as appropriate without departing from the scope and spirit of the present invention.

### REFERENCE SIGNS LIST

1 DATA UPDATE SYSTEM
100 CENTER SERVER
11 AUTHENTICATION PROCESSING UNIT
12 DISTRIBUTION PROCESSING UNIT
13 DATABASE
14 PARAMETER STORAGE UNIT
15 SOFTWARE STORAGE UNIT
101 CALCULATION UNIT
102 STORAGE UNIT
103 COMMUNICATION INTERFACE
200 CHARGING STAND
21 DISPLAY UNIT
22 AUTHENTICATION CODE PROVISION PROCESSING UNIT
23 UPDATE PROCESSING UNIT
24 COMMUNICATION LINE INTERFACE
201 CALCULATION UNIT
202 STORAGE UNIT
203 COMMUNICATION INTERFACE
205 CHARGING INTERFACE
300 USER TERMINAL
301 CALCULATION UNIT
302 STORAGE UNIT
303 COMMUNICATION INTERFACE
304 DISPLAY UNIT
305 IMAGE CAPTURING UNIT
400 VEHICLE
41 AUTHENTICATION-NOT-REQUIRED DATA STORAGE AREA
42 VEHICLE BODY DATA STORAGE AREA
43 AUTHENTICATION-REQUIRED DATA STORAGE AREA
401 ACCESS GUARD UNIT
402 CONNECTION FORM RECOGNITION UNIT
403 ACCESS CONTROL UNIT
404 ACCESS CONTROL UNIT
405 ACCESS CONTROL UNIT
406 USB PORT
407 RADIO COMMUNICATION INTERFACE
408 CHARGING CABLE CONNECTION PORT
50 USB INTERFACE
60 OTA INTERFACE

What is claimed is:

1. A data update system comprising:
a user terminal operated by a user;
a center server configured to perform authentication processing and distribution of data; and
a charging stand comprising a charging cable connected to a vehicle and a communication line through which data communication with the vehicle is performed, the charging stand being configured to charge the vehicle, wherein
the user terminal performs authentication request processing for transmitting authentication information including at least an authentication code provided by the charging stand to the center server,
the center server performs
authentication processing for confirming whether or not the authentication information is valid, and
distribution processing for causing the charging stand to download the data to be updated in response to the authentication processing confirming the validity, and
the charging stand performs
authentication code provision processing for providing the authentication code in response to a connection of the charging cable to the vehicle, and
data update processing for updating data of a vehicle to be updated by providing the downloaded data to the vehicle to be updated through the communication line.

2. The data update system according to claim 1, wherein the charging cable is integrated with the communication line.

3. The data update system according to claim 1, wherein the center server calculates an estimated amount of time required to update data and an estimated amount of time required to perform charging processing in which the charging stand charges the vehicle in response to the authentication processing confirming the validity, and displays the calculated estimated amount of time on a display unit of the charging stand or the user terminal.

4. The data update system according to claim 1, wherein the charging stand provides the data to the vehicle when the user selects execution of the data update processing in a selection screen displayed on a display unit provided in the user terminal or the charging stand.

5. The data update system according to claim 1, wherein the authentication code is a one-time password updated by the center server.

6. The data update system according to claim 1, wherein the center server acquires vehicle body data generated by an operation of the vehicle after the updating of the data and performs validity diagnosis processing for performing validation of a state of the vehicle after the updating of the data.

7. The data update system according to claim 1, wherein the vehicle comprises an access guard unit configured to recognize forms of connection with an external apparatus or medium and controls an access range in accordance with a difference in the forms of connection.

8. The data update system according to claim 7, wherein the access guard unit recognizes at least a wired connection through the communication line provided in the charging stand and a radio connection as the forms of connection.

9. The data update system according to claim 7, wherein
the vehicle comprises a first information accumulation unit, a second information accumulation unit, and a third information accumulation unit,
the access guard unit restricts access to the second information accumulation unit when the access guard unit recognizes a form of connection other than a wired connection through the communication line provided in the charging stand and a radio connection, and
the access guard restricts access to the third information accumulation unit when the access guard unit recognizes a form of connection other than a wired connection through the communication line provided in the charging stand.

10. The data update system according to claim 9, wherein
the first information accumulation unit accumulates data that does not require authentication by the center server,
the second information accumulation unit accumulates data indicating a state of the vehicle and a history of the state of the vehicle, and
the third information accumulation unit accumulates data accessible when the authentication processing performed by the center server has confirmed the validity.

11. The data update system according to claim 1, wherein the center server notifies the user terminal that the data needs to be updated.

12. The data update system according to claim 1, wherein
the charging stand downloads the data from the center server in advance when the user terminal notifies the charging stand that the data is to be updated, and
the charging stand provides the downloaded data to the vehicle when the communication line is connected to the vehicle to be updated and the authentication processing has confirmed the validity.

13. The data update system according to claim 1, wherein the authentication information further includes user information registered in advance and position information of the charging stand and the user terminal.

14. A non-transitory computer readable medium storing a data update program executed in a data update system comprising a center server, a charging stand, and a user terminal by a calculation unit provided in each of these apparatuses, wherein
a first program executed in the user terminal performs authentication request processing for transmitting authentication information including at least an authentication code displayed on the charging stand to the center server,
a second program executed in the center server performs
authentication processing for confirming whether or not the authentication information is valid, and
distribution processing for causing the charging stand to download data to be updated in response to the authentication processing confirming the validity,
the charging stand comprises a charging cable connected to a vehicle and a communication line through which data communication with the vehicle is performed, and
a third program executed in the charging stand performs
authentication code provision processing for providing the authentication code in response to a connection of the charging cable to the vehicle, and
data update processing for providing the downloaded data to a vehicle to be updated through the communication line.

15. A data update method performed in a data update system comprising a center server, a charging stand, and a user terminal, wherein
in the user terminal, authentication request processing for transmitting authentication information including at least an authentication code displayed on the charging stand to the center server is performed,
in the center server, authentication processing for confirming whether or not the authentication information is valid and distribution processing for causing the charging stand to download data to be updated in response to the authentication processing confirming the validity are performed,
the charging stand comprises a charging cable connected to a vehicle and a communication line through which data communication with the vehicle is performed, and
in the charging stand, authentication code provision processing for providing the authentication code in response to a connection of the charging cable to the vehicle and data update processing for providing the downloaded data to a vehicle to be updated through the communication line are performed.
